(19) United States
(12) Patent Application Publication
(10) Pub. No.: US 2026/0009737 A1
(43) Pub. Date: Jan. 8, 2026

(54) METHOD FOR DETECTING DEFECTS IN THE WOOD AND PROPERTIES OF THE DEFECTS IN THE WOOD DURING THE PROCESSING OF LOGS AND DEVICE FOR PROCESSING LOGS

(71) Applicant: Gebrüder Linck, Maschinenfabrik 'Gatterlinck' GmbH & Co. KG, Oberkirch (DE)

(72) Inventors: Jörn RATHKE, Oberkirch (DE); Raphael BURGER, Offenburg (DE)

(73) Assignee: Gebrüder Linck, Maschinenfabrik 'Gatterlinck' GmbH & Co. KG, Oberkirch (DE)

(21) Appl. No.: 19/256,952

(22) Filed: Jul. 1, 2025

(30) Foreign Application Priority Data
Jul. 4, 2024 (EP) 24186479.2

(51) Int. Cl. G01N 21/898; G01N 21/89

(52) U.S. Cl. CPC G01N 21/8986; G01N 21/8914

(57) ABSTRACT

A method for detecting defects in the wood and/or properties of the defects in the wood during the processing of a log, having the steps of: A) measuring a profile of the log (1) and determining a log geometry of the log; B) processing the log (1) by cutting so as to produce a processing surface (8) along a log axis of the log (1); C) imaging inspection of the log (1) processed by cutting at least on the processing surface (8) and determination of at least one inspection image (14); and D) using the inspection image (14) from method step C) and the log geometry from method step A) as a basis for spatially resolved determination of a defect (10) in the wood and/or a property of the defect in the wood on the log processed by cutting.

### CROSS-REFERENCE TO RELATED APPLICATIONS

This application claims priority to European Patent Application No. 24186479.2, filed Jul. 4, 2024, which is incorporated herein by reference as if fully set forth.

### TECHNICAL FIELD

The invention relates to a method for detecting defects in the wood and/or properties of the defects in the wood during the processing of logs. The invention also relates to a device for processing logs.

### BACKGROUND

In industrial timber processing, logs are processed to produce boards, among other things. One aim here is to achieve the highest possible timber yield. For this, the arrangement in which and the dimensions with which the boards to be obtained have to be arranged in relation to the log geometry is typically determined in order to be able to achieve the desirably high timber yield. For this purpose, the log is first scanned by means of a profile sensor. A three-dimensional log geometry is identified from the measured data thus obtained and, on the basis thereof, the arrangement and the dimensions of the boards to be obtained are determined. So-called main product boards are typically situated here in an inner cross-sectional area of a log, while so-called side product boards are arranged in an outer cross-sectional area compared thereto.

To obtain a side product board, this is usually profiled directly on the log, wherein the log usually initially exists as so-called round timber with a substantially round cross section, which is caused by the natural growth of the log. For the profiling of the side product board, at least one slab area of the log is first removed and this creates at least one processing surface. In such a state processed by cutting, the log may also have not only one, but also multiple circumferentially distributed processing surfaces and may be present, for example, as a so-called model with two lateral processing surfaces or as squared timber with four circumferentially distributed processing surfaces.

After processing the log by cutting, it is usually scanned again using a profile sensor in order to determine its geometry. The geometry information collected for the log processed by cutting is used to detect defects in the wood, such as cracks or branches which extend through the log interior, in a spatially resolved manner. A profile measurement after processing by cutting also makes it possible to identify whether the processing surface has been produced on the log at the desired position and in the desired orientation. This makes it possible, after the processing by cutting, to determine the dimensions and arrangements of the main and side product boards to be obtained in relation to the log processed by cutting or to change them from an original sawing solution, such that said log can then be processed accordingly.

It is a disadvantage that the profile measurement of the log processed by cutting is associated with a high metrological effort. It is therefore the object of the invention to enable reliable quality inspection and a high timber yield during the processing of logs at the same time as low metrological effort.

### SUMMARY

The object is achieved by means of a method having one or more of the features disclosed herein. Advantageous developments are described below and in the claims. The object is also achieved by a device having one or more of the features described herein.

The method according to the invention is used for detecting defects in the wood and/or properties of the defects in the wood during the processing of a log and comprises the following method steps:

A) measurement of the profile of the log and determination of a log geometry of the log;

B) processing of the log by cutting so as to produce at least one processing surface along a log axis of the log;

C) imaging inspection of the log processed by cutting at least on the processing surface and capturing of at least one inspection image; and

D) use of the inspection image from method step C) and the log geometry from method step A) for spatially resolved determination of a defect in the wood and/or a property of the defect in the wood on the log processed by cutting.

The invention is based on the knowledge that it is not necessary to collect information relating to its geometry both before and after the processing of the log by cutting. Instead, the inventive idea is based on the fact that the quality-relevant information, such as a position or spatial spread of a defect in the wood, can be obtained on the one hand on the basis of the log geometry of the log before it is processed by cutting, and on the other hand on the basis of comparatively easy-to-obtain image data on the log processed by cutting. This makes it possible, contrary to common practice, to determine, even without a profile measurement of the log processed by cutting, in which arrangement and with which dimensions the boards to be obtained should be arranged in relation to the log processed by cutting in order to achieve the highest possible timber yield and a high sawn timber quality.

In one conceivable embodiment, the log is moved substantially along a log axis in a feed direction in order to carry out at least one of method steps A), B), C), D). It is conceivable that the log axis is straight or has at least one or more curvatures which may be caused by the natural growth of the log. Accordingly, the processing surface of the log along the log axis may have a substantially straight or curved profile.

Preferably, the log is present in method step A) as round timber and has a substantially round cross-sectional course on the outer circumferential side and along its log axis, which is caused by the natural growth of the log. Method step A) is preferably carried out by means of one or more profile sensors which can each be designed, for example, in the manner of a laser light section sensor or a comparable measuring means and can be used to determine a geometric profile of the log. In this case, the scope of the invention includes the fact that the profile sensor and the log move relative to one another, wherein the profile sensor in particular can be mounted at rest and the log is delivered in a feed movement in the feed direction. The log geometry can be determined in this case on the basis of the profile information collected and the feed direction of the log.

The log geometry can be represented in the context of the invention by a point cloud or comparable primary data which are collected in method step A). In the context of the invention, this point cloud can represent the surface of the log and thus describe a spatial extent of the log or a part of the log. The scope of the invention also includes the fact that a log model representing the log geometry is generated on the basis of the primary data. In comparison to the primary data, the log model can have a higher data density and in particular have an at least partially closed surface, which essentially corresponds to the surface of the log in method step A). It is conceivable that the log model is in this case present in the form of an envelope model, which represents only the outer surface of the log. It is also conceivable that the log model is present in the manner of a solid model with a virtual log interior.

The invention is not limited to the manner in which method step B) is carried out. It is conceivable that the processing of the log by cutting and the creation of the processing surface is carried out by means of one or more sawing means, wherein a slab area of the log is separated from the log in one continuous piece. It is also conceivable that the slab area is processed, for example by means of a milling head, into wood chips and the processing surface is produced in the process.

The imaging inspection of the log processed by cutting according to method step C) can be carried out by means of one or more imaging sensors, where in particular cameras or a camera system can be used. The imaging sensor can at least represent the processing surface of the log in the inspection image by two-dimensionally distributed gray scale and/or RGB color values.

In particular, the at least one imaging sensor may be arranged such that the log processed by cutting passes with its processing surface through a capturing area of the imaging sensor during the feed movement. In this case, the imaging sensor may have a measuring axis which indicates a spatial extent of its capturing range and along which the at least one imaging sensor has a depth of field range. In the depth of field range, it is possible to use the imaging sensor to produce sufficiently sharp inspection images from the processing surface.

It is advantageous if, during method step C), the sensor is aligned with its measuring axis substantially orthogonal to the processing surface. This can be achieved in a simple way, since the feed movement of the log processed by cutting is typically produced by means of a plurality of feed rollers, the outer surfaces of which are in substantially flush contact with the processing surface. Therefore, the imaging sensor can be aligned with its measuring axis orthogonal to the roller axes, for example, in order to be able to align with its measuring axis perpendicular to the processing surface of a log processed by cutting. The sensor can also be aligned on the basis of another system component, by means of which the processing surface of the log processed by cutting is guided.

It is also conceivable that the imaging sensor is aligned with its measuring axis at an angle relative to the processing surface, in particular at an angle between 0 and 90°. As a result of the spatial extent of the depth of field range of the imaging sensor along the measuring axis, the processing surface can also be captured sufficiently sharply in the above-mentioned angular alignment with respect to the measuring axis. In particular, a correction step can be used to compensate for a trapezoidal distortion of the captured processing surface, for example by means of a keystone correction.

In method step D), as described above, a spatially resolved determination of the defect in the wood and/or the property of the defect in the wood is carried out. The invention is generally not limited to the type of defect in the wood or property of the defect in the wood that is determined. However, it is relevant that these can be determined in a spatially resolved manner with respect to the geometry of the log processed by cutting. In other words, a spatial position and/or extent on the log processed by cutting is determined for the defect in the wood or property of the defect in the wood on the processing surface. In particular, method step D) is carried out independently of a piece of geometric information on the processing surface of the log processed by cutting.

A defect in the wood may include a branch and/or a knothole and/or a split and/or warping and/or discoloration and/or rot and/or sapwood and/or insect infestation. A property of the defect in the wood may describe a manifestation of a defect in the wood, in particular one of the above defects.

The determination of the defect in the wood may include a data processing step by means of which the inspection image collected during the imaging inspection is evaluated. This may preferably include image processing, in which in particular filtering and/or edge detection and/or segmentation and/or a morphological operation and/or feature extraction and/or pattern recognition and/or pattern classification and/or texture analysis and/or histogram analysis is performed on the inspection image or a part thereof in order to capture the defect in the wood and/or the property of the defect in the wood. In particular, the determined position and/or spread of the defect in the wood can be represented on the inspection image by means of an error polygon.

In one advantageous development, a virtual log model which at least partially represents the log geometry and is provided with at least one profile section is generated in method step A). This creates a virtual processing plane on the virtual log model. The spatially resolved determination of the defect in the wood is carried out by virtue of the inspection image or information derived therefrom being projected onto the virtual log model in the virtual processing plane.

The development described above is based on the knowledge that the log in method step B) is typically processed in such a way that the resulting processing surface can be simulated virtually on the log model from method step A). In other words, a virtual twin of the log is generated on the basis of the log model, said virtual twin being based on the profile measurement from method step A) on the one hand and on an adaptation of the log model on the other, in particular according to the processing by cutting according to method step B). This virtual twin is taken as a basis for performing the quality inspection of the log by inserting the inspection image or a part thereof into the cut area of the log model. This virtual twin of the log can basically correspond pictorially to a cylinder or hollow cylinder which is flattened on one side and is provided with the inspection image or a part thereof on the flattened side.

In particular, instead of the inspection image, the error polygon, which indicates the position of the defect in the wood in the inspection image, can be projected onto the log model. Such an error polygon may originate from an upstream data processing step of the inspection image. In other words, it is not necessary to visually combine the log model and the inspection image or parts thereof so that the defect in the wood can be determined in a spatially resolved manner with respect to the geometry of the log processed by cutting. Instead, the defect in the wood and/or the property of the defect in the wood can be identified separately from the determination of the position and/or extent of the respective defect in the wood on the log processed by cutting.

In one advantageous development, in method step D), the defect in the wood and/or the property of the defect in the wood is thus identified on the basis of the inspection image and a position and/or spread of the defect in the wood and/or the property of the defect in the wood in relation to the log processed by cutting is determined on the basis of a common feature between the inspection image and the log model.

An advantage of the development described above is that the defect in the wood and/or the property of the defect in the wood can first be identified in a simple manner in a first substep D1) exclusively on the basis of the inspection image. Only in a subsequent second substep D2) is it possible to determine the common feature contained in both the inspection image and the log model. Thus, the inspection image or the part containing the defect in the wood can be projected highly precisely into the virtual processing plane of the log model and it can thus be determined in a spatially resolved manner how the defect in the wood and/or the property of the defect in the wood is arranged on the log processed by cutting.

In one advantageous development, at least one virtual wane is generated on the virtual log model by the profile section in the virtual processing plane, said virtual wane being taken as a basis for the spatially resolved determination of the defect in the wood and/or the property of the defect in the wood.

In the context of the invention, the term wane can be understood in principle as a geometric feature on a log processed by cutting which separates the processing surface and an unprocessed wane region from one another. The wane area can be considered as an outer circumferential area of the log with a rounded geometry due to the natural growth of the log.

Studies have shown that at least one wane can serve as a reference feature in order to be able to align the inspection image or part thereof with the virtual log model during projection and thus achieve a high degree of accuracy in the spatially resolved determination of the defect in the wood and/or the property of the defect in the wood. In particular, two virtual wanes can also be generated by the profile section, including a virtual processing surface in the virtual processing plane and thus specifying a projection area in which the inspection image or information derived therefrom, for example an error polygon, can be projected.

In one advantageous development, the imaging inspection is carried out in method step C) in such a way that at least one wane adjoining the processing surface is detected and the spatially resolved determination of the defect in the wood and/or the property of the defect in the wood is effected in method step D) on the basis of a comparison between the virtual wane of the virtual log model and the wane of the log processed by cutting and adjoining the processing surface.

Studies by the applicant have shown that the wane extends substantially along the log axis and may have a profile course in a plane formed by the processing surface, which profile course is in particular individualizing for the log processed by cutting. Similarly, a virtual wane may have a course resulting from the profile section of the virtual log model in the virtual processing plane. Studies by the applicant have also shown that the courses of an actually produced wane and a virtual wane are usually sufficiently similar, at least in the virtual processing plane, so that it is possible to align the inspection image with the virtual log model on the basis of the course of the wane.

The scope of the advantageous development includes the fact that the virtual wane of the virtual log model and the wane of the log processed by cutting and adjoining the processing surface are compared by means of a computer and an evaluation routine implemented thereon. In particular, it is conceivable that the respective wanes are identified using data processing methods, in particular by means of an analytical algorithm and/or on the basis of machine learning or artificial intelligence, and the position and/or size and/or orientation in which the inspection image or information derived therefrom, in particular the error polygon, must be positioned in the virtual processing plane is determined. The spatially resolved determination of the defect in the wood and/or property of the defect in the wood can then be carried out on the basis thereof.

In one advantageous development, a position and/or orientation of the virtual processing plane on the virtual log model is defined for the profile section on the basis of the nominal rotational position of the log in method step B).

The development described above is based on the knowledge that the log is usually rotated about its log axis for processing thereof before it can be moved against the respective separating means used in order to produce the processing surface in method step B). The required rotational position is determined on the basis of the log geometry. In this respect, it is also possible to take the log geometry in method step A) and the nominal rotational position of the log in method step B) as a basis for determining the position and orientation in which the virtual processing plane must be arranged on the virtual log model in order to provide same with the profile section. The advantageous development is also based on the knowledge that a rotational position of the log can typically be set sufficiently precisely for the processing by cutting in method step B), so that the processing surface produced is in the desired position and orientation on the log. In other words, the position and/or orientation of the virtual processing plane can be defined on the basis of the assumption that there is no deviation between the nominal rotational position and the actual rotational position of the log during the processing by cutting in method step B).

In one conceivable embodiment, the log is thus rotated about its log axis between method step A) and the processing by cutting in method step B) in order to bring the log by way of the slab area to be removed into the required position for processing by cutting. The nominal rotational position of the log required for this purpose can be determined on the basis of the log geometry from method step A) and this can be converted into a corresponding control program, on the basis of which the rotation and feed movement of the log takes place. Using this control information, it is possible to use a computer, for example, to position the virtual processing plane such that it is substantially identical to the processing surface of the log processed by cutting in relation to the virtual log geometry and thus represents this sufficiently precisely.

Due to the natural shape of logs or other disruptive influences in the industrial processing of logs, it is conceivable that the logs exhibit a twist error during the processing by cutting in method step B) and the processing surface is produced with a deviation from the desired position and/or orientation thereof on the log. If the log model is provided with the profile section in this case, assuming the nominal rotational position of the log, there are differences between the processing surface and the wanes compared to their virtual counterparts on the log model.

Studies by the applicant have shown that it is possible to use the imaging inspection to determine the processing surface or, for example, the course of an adjoining wane on the basis of the inspection image and then to determine the position and/or orientation in which the virtual processing plane must be located in order that an identical or at least similar virtual processing surface and/or virtual wane arises by way of a profile section of the log model.

In one advantageous development, a position and/or orientation of the virtual processing plane on the virtual log model is defined for this purpose on the basis of the processing surface and/or at least one wane of the inspection image. In particular, the virtual processing plane is defined on the virtual log model by virtue of a virtual processing surface and/or virtual wane of the log model which is identical or at least similar in each case to the processing surface and/or wane of the inspection image being determined. The position and/or orientation of the virtual processing plane is selected such that it passes through the determined virtual processing surface and/or virtual wane and in particular contains same.

For example, the virtual processing plane can be determined by iteratively cutting the log model in a variety of different positions and angles. In the resulting cutting planes, a comparison with the processing surface and/or wane of the inspection image can be performed. In particular, a similarity criterion can be defined, on the basis of which the position of the virtual processing plane is defined. It is also conceivable that the virtual processing plane is determined by inputting the processing surface and/or the wane course as well as the log model into a calculation model, and the position and/or orientation of the virtual processing plane is determined explicitly and in particular in a single calculation step.

In one advantageous development, a sawing solution is determined or optimized in a method step E) on the basis of the spatially resolved defect in the wood and/or a property of the defect in the wood.

A sawing solution may include an arrangement of main and/or side product boards and their respective dimensions relative to the log geometry. As part of method step E), the sawing solution can be redetermined or an existing sawing solution can be optimized, especially in the context of re-optimization. In particular, a first sawing solution may be determined as early as on the basis of the profile measurement in method step A), on the basis of which method step B) is carried out. After the processing by cutting and the imaging inspection in method step C) and method step D), the spatially resolved determination in method step D) can be used to determine a second sawing solution, in which the defect in the wood and/or the property of the defect in the wood are taken into account. In this case, a defective log area can be eliminated or the dimension and/or position of a wooden board to be produced can be changed compared to the first sawing solution. In particular, a subdivision of two side product boards may also be changed with regard to their relative position to one another and their dimensions relative to the first sawing solution.

In one advantageous development, the log is processed by cutting according to method step E) according to the sawing solution. This includes in particular further processing of the log by cutting, in which, for example, the side products are profiled on the log and then separated from the log.

As mentioned above, the object is also solved by a device as claimed in claim 12. Said device comprises a delivery means intended to transport a log along its log axis in a feed direction, a profile sensor arranged in such a way as to determine a log geometry during the delivery movement of the log. The device furthermore comprises a first separating means arranged and designed in such a way as to engage with the log during the delivery movement by cutting it and to produce a processing surface, an image sensor arranged in such a way as to inspect the processing surface, a computer configured to determine a defect in the wood and/or a property of the defect in the wood on the log processed by cutting in a spatially resolved manner and on the basis of the inspection image and the log geometry.

In particular, the device according to the invention is suitable for carrying out the method according to the invention or an advantageous development thereof. In particular, the method according to the invention or an advantageous development thereof can be carried out by means of the device according to the invention or an advantageous development thereof. In this respect, the embodiments with regard to the above-described method apply correspondingly in respect of the conceivable refinements of the device as well as the advantages achievable therewith.

### BRIEF DESCRIPTION OF THE DRAWINGS

Advantages and possible refinements of the method according to the invention are explained below with reference to exemplary embodiments and the figures. In the figures

FIG. 1 shows a log, the log geometry of which is determined and from which a virtual log model is generated;

FIG. 2 shows the log during processing by cutting and adaptation of the log model;

FIG. 3 shows an imaging inspection of the log and projection of an inspection image onto the virtual log model;

FIG. 4 shows an adaptation of the log model on the basis of an inspection image;

FIG. 5 shows further processing by cutting on the basis of the imaging inspection.

### DETAILED DESCRIPTION

In industrial timber processing, logs are usually processed to form boards, which are obtained from different cross-sectional areas of the logs. Those boards that are obtained from an inner cross-sectional area of a log are referred to as main product boards. Boards that in comparison are obtained from an outer cross-sectional area are referred to as side product boards. Side product boards are usually profiled directly on the log. This involves removing a slab area from the log in one piece or by processing it to form wood chips, thereby producing a substantially flat processing surface. The processing surface in this case usually represents the wide side of a side product board. If the log is processed on several sides, it can be present after the processing by cutting as a so-called model with two lateral processing surfaces or for example as square timber with four circumferentially distributed processing surfaces. After the processing by cutting, the log processed by cutting is scanned by means of at least one profile sensor. This allows inner defects in the wood with a three-dimensional extent, such as cracks or branches, to be identified.

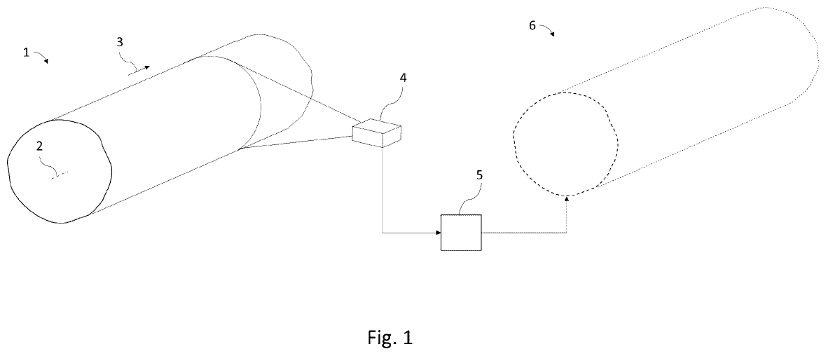

The above-described measures of quality inspection and processing of logs are associated with a high metrological effort, but are due to the common practice in the way of carrying out the method in timber processing. Method steps which enable the achievement of comparable advantages with a significantly lower metrological effort are described with reference to FIGS. 1 to 5 below.

FIG. 1 shows a log 1 which has a substantially cylindrical basic geometry extending along its log axis 2. The log 1 has an irregular surface profile which is caused by its natural growth.

The log 1 is delivered in a feed direction 3 and thereby reaches a capture range of several profile sensors 4, of which only one profile sensor 4 is shown in the exemplary embodiment shown here. The profile sensors 4 can, for example, each be designed as laser light section sensors. A log geometry of the log 1 is determined on the basis of the feed movement, in particular a relative speed relative to the profile sensors 4, by virtue of a plurality of profile images being input into a computer 5 which generates a virtual log model 6 based on a point cloud. The virtual log model 6 has a geometry at least on an outer circumferential side that essentially corresponds to the geometry of the log 1.

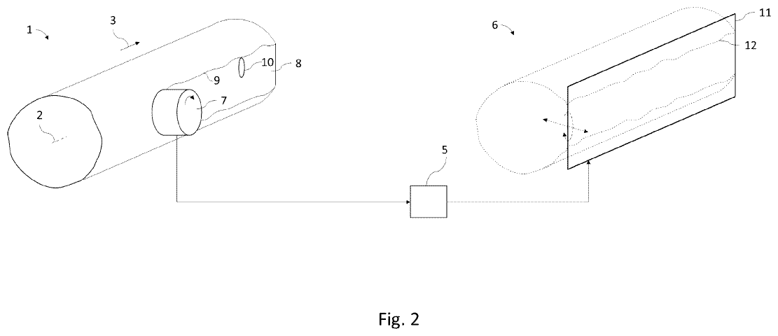

In a subsequent step, which is shown in FIG. 2, the log 1 is processed by means of a rotating milling head 7, which produces a substantially planar processing surface 8 which is laterally bounded by two wanes 9. For a better overview, only one of the wanes 9 is provided with a reference sign in FIG. 2. In a manner likewise not shown in more detail, the log 1 processed by cutting may have not only one, but for example two or for instance four circumferentially distributed processing surfaces 8 and be present as a so-called model or square timber after the processing by cutting.

The wanes 9 extend substantially along the log axis 2 and have, at least in one plane formed by the processing surface 8, a characteristic course which is caused by the natural growth of the log 1. As a result of the processing of the log 1 by cutting, a defect 10 in the wood is exposed at the processing surface 8. As mentioned in the introduction, this has a negative effect on the quality of the boards to be obtained, the surface of which is at least partially limited by the processing surface 8.

In order to be able to take into account the defect 10 in the wood for the further processing of the log 1, the virtual log model 6 is provided with a profile section in a virtual processing plane 11. Two virtual wanes 12 extend along this profile section, only one of which is provided with a reference numeral in FIG. 2.

The position and orientation of the virtual processing plane 12 on the virtual log 6 is generated on the basis of the nominal rotational position of the log 1, after it has been processed by cutting. This is usually present in the computer 5, which controls the processing of the log 1 by cutting as well as its delivery movement. Using this control information, it is possible to determine a nominal rotational position of the log 1 during the processing by cutting and to position the virtual processing plane 11 with respect to the virtual log model 6 in such a way that it runs according to the plane in which the actually produced processing surface 8 is present on the log 1.

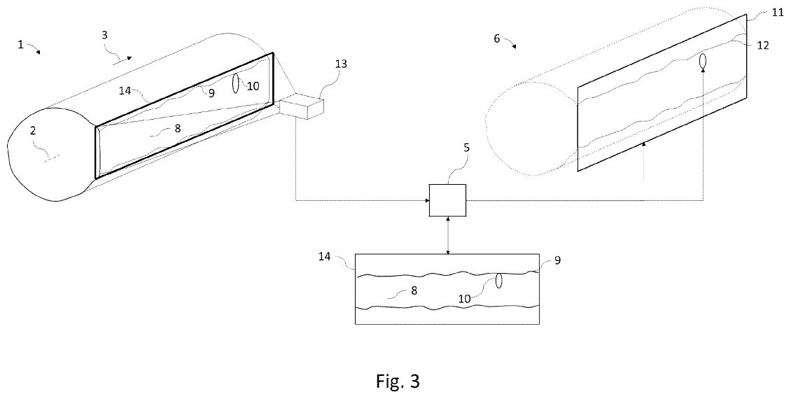

After the steps illustrated in FIG. 2, the log 1 continues to be delivered in the feed direction 3 and, as shown in FIG. 3, reaches a capture area of at least one imaging sensor 13. This is oriented in such a way that the processing surface 8 is arranged substantially orthogonal to a measuring axis of the imaging sensor 13. Such an orientation of the log 1 can be carried out, for example, by suitable actuation of the delivery or handling means, by means of which the log is moved in the feed direction 3.

The imaging sensor 13 is used to capture an inspection image 14 which fully captures both the processing surface 8, the defect 10 in the wood located therein and the wanes 9 of the log 1 processed by cutting. In a manner not shown here, only a part of the processing surface 8 and/or the wanes 9 can be captured.

On the basis of the inspection image 14, the defect 10 in the wood is first identified by means of the computer 5. This can be done using digital image processing or, for example, using an algorithm based on machine learning or artificial intelligence. The inspection image 14 or only the identified defect 10 in the wood or a corresponding error polygon is then projected into the virtual processing plane 11 of the virtual log model 6. It is relevant that for this purpose the inspection image 14 is compared with the virtual wanes 12 on the basis of the wanes 9 contained in said image and that the inspection image 14 or defect 10 in the wood or error polygon is positioned on the virtual log model 6 on the basis of this. This makes it possible to determine the position and extent of the defect 12 in the wood and its properties of the defects in the wood with high precision and in a spatially resolved manner in relation to the log geometry of the log 1.

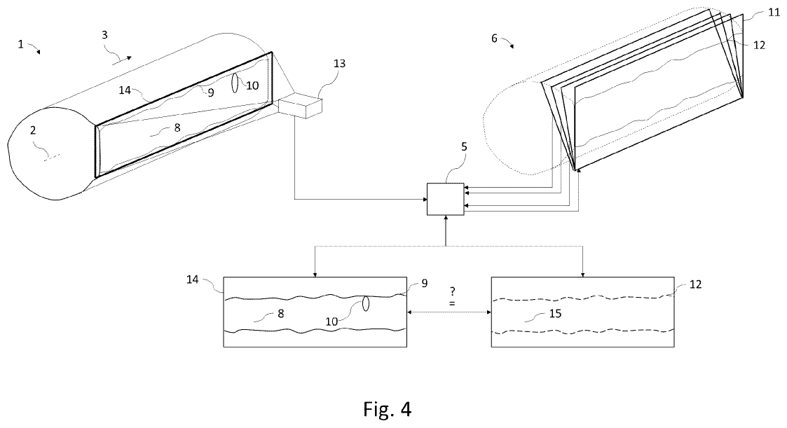

Due to unavoidable positioning inaccuracies, the log 1 may have a twist error during the processing by cutting and the processing surface may be generated with a deviation from its desired position or orientation on the log 1. As shown in FIG. 4, it is possible to use the imaging inspection of the processing surface 8 on the log 1 processed by cutting to determine the shape or dimension of the processing surface 8 or, for example, the course of one or two adjacent wanes 9 on the basis of the inspection image 14. Subsequently, the log model 6 can be used to determine the position and/or orientation in which the virtual processing plane 11 must be located so that an identical or at least similar virtual processing surface 15 or virtual wane 12 results from a profile section of the log model 6.

As shown in FIG. 4, for example, the log model 6 can be sawn for example iteratively with a plurality of possible sawing planes and, on the basis of the respective sawing, a corresponding number of virtual processing surfaces 15 or virtual wanes 12 on the log model 6 can be determined. The computer 5 compares the captured inspection image 14 and in particular the processing surface 8 and/or wane 9 contained therein with the saw cuts of the log model 6 and the virtual processing surfaces 15 and virtual wanes 12 contained therein. If there is a sufficient similarity, the relevant sawing plane is defined as virtual processing plane 11 and the inspection image 14 or, for example, a defect polygon is projected into same. It is also conceivable that the position and/or orientation of the virtual processing plane 11 is determined by inputting the processing surface and/or the wane course as well as the log model 6 into a calculation model, and the position and/or orientation of the virtual processing plane 11 is determined explicitly and in particular in one calculation step based on a similarity criterion.

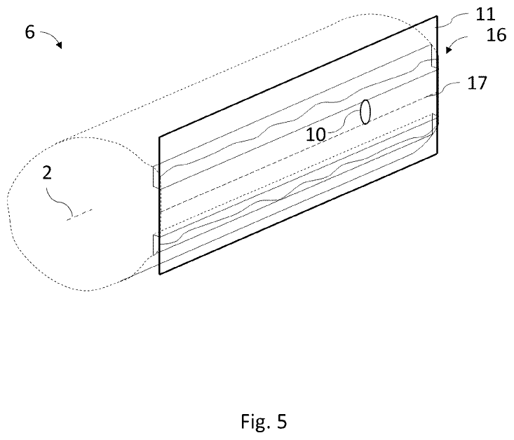

By means of an exact spatially resolved determination of the defect 10 in the wood or the properties of the defects in the wood, it is possible to determine a sawing solution according to which the log 1 can be processed for an optimal timber yield. This is illustrated with reference to FIG. 5. Accordingly, for example, the side products can be profiled by milling out two adjoining wane areas 16 or, for example, the division of two adjacent side product boards by a scoring plane 17 can be changed so that only one of the side product boards is affected by the defect 10 in the wood and the other side product board is not affected.

1. A method for detecting defects in wood and/or properties of the defects in the wood during processing of a log, the method comprising the following method steps:
A) measuring a profile of the log (1) and determining a log geometry of the log;
B) processing the log (1) by cutting so as to produce a processing surface (8) along a log axis of the log (1);
C) imaging inspection of the log (1) processed by cutting at least on the processing surface (8) and capturing at least one inspection image (14);
D) using the inspection image (14) from method step C) and the log geometry from method step A) as a basis for spatially resolved determination of a defect (10) in the wood and/or a property of the defect in the wood on the log processed by cutting.

2. The method as claimed in claim 1, further comprising:
taking the log geometry from method step A) as a basis for generating a virtual log model (6) and generating the virtual log model (6) is provided with at least one profile section in a virtual processing plane (11), and carrying out the spatially resolved determination of the defect in the wood and/or the property of the defect in the wood by projecting the inspection image (14) determined in method step C) or a piece of information derived therefrom onto the virtual log model (6) in the virtual processing plane.

3. The method as claimed in claim 2, wherein
method step D) further comprises:
a substep D1), including identifying the defect (10) in the wood and/or the property of the defect in the wood in the inspection image (14), and
a substep D2), determining a position and/or spread of the defect in the wood and/or the property of the defect in the wood on the log (1) processed by cutting based on a common feature between the inspection image (14) and the virtual log model (16).

4. The method at least as claimed in claim 2, further comprising:
generating at least one virtual wane (12) on the log model (6) by the profile section in the virtual processing plane (11), on the basis of which the spatially resolved determination of the defect (10) in the wood and/or the property of the defect in the wood is carried out.

5. The method as claimed in claim 4, wherein
the imaging inspection is carried out in method step C) such that a wane (9) adjoining the processing surface (8) is detected and the spatially resolved determination of the defect in the wood and/or the property of the defect in the wood is carried out in method step D) on the basis of a comparison between the virtual wane (12) of the log model (6) and the wane (9) of the log (1) processed by cutting and adjoining the processing surface (8).

6. The method at least as claimed in claim 2, further comprising:
defining a position and/or orientation of the virtual processing plane (11) on the virtual log model (6) based on a nominal rotational position of the log (1) in method step B).

7. The method at least as claimed in claim 2, further comprising:
defining a position and/or orientation of the virtual processing plane (11) on the virtual log model (6) based on the processing surface (8) and/or at least one wane (9) of the inspection image (14).

8. The method as claimed in claim 7, further comprising:
defining the virtual processing plane (11) on the virtual log model (6) by virtue of a virtual processing surface (15) and/or virtual wane (12) which is identical or at least similar to the processing surface (8) and/or wane (9) of the inspection image (14) being determined.

9. The method of claim 8, wherein the position and/or orientation of the virtual processing plane (11) is selected such that it contains the determined virtual processing surface (15) and/or the virtual wane (12).

10. The method as claimed in claim 7, wherein
method step D) is carried out independently of a piece of geometric information on the processing surface (8) of the log (1) processed by cutting.

11. The method as claimed in claim 1, wherein
a sawing solution is determined in method step E) based on the spatially resolved defect (10) in the wood and/or the property of the defect in the wood.

12. The method as claimed in claim 10, further comprising:
processing the log (1) by cutting according to the sawing solution according to method step E).

13. A device for processing a log, the device comprising:
a delivery device that is adapted to transport a log (1) along a log axis thereof in a feed direction (3),
a profile sensor (4) arranged and configured to determine a log geometry during a delivery movement of the log (1),
a first separator (7) arranged and configured to engage with the log (1) during the delivery movement and to cut the log to produce a processing surface,
an image sensor (13) arranged and configured to inspect the processing surface (8) and to output an inspection image (14), and
a computer (5) configured to determine a defect (10) in the wood and/or a property of the defect in the wood on the log processed by cutting in a spatially resolved manner and based on the inspection image (14) and the log geometry.
